(19) United States
(12) Patent Application Publication
(10) Pub. No.: US 2019/0294931 A1
(43) Pub. Date: Sep. 26, 2019

(54) Systems and Methods for Generative Ensemble Networks

(71) Applicant: Artomatix Ltd., Dublin (IE)

(72) Inventors: Eric Andrew Risser, Sarasota, FL (US); Oisin Benson, Dublin (IE)

(73) Assignee: Artomatix Ltd., Dublin (IE)

(21) Appl. No.: 16/365,479

(22) Filed: Mar. 26, 2019

Related U.S. Application Data
(60) Provisional application No. 62/648,344, filed on Mar. 26, 2018.

(51) Int. Cl. G06K 9/62; G06T 3/40

(52) U.S. Cl. CPC G06K 9/6263; G06T 3/4046; G06T 3/4053

(57) ABSTRACT

Systems and methods for training a generative ensemble network to generate image data in accordance with embodiments of the invention are illustrated. One embodiment includes a method for generating an image through an ensemble network architecture. The method includes steps for passing a set of one or more images through a single standard convolution layer that acts as a root node to produce a first output and passing the first output through a plurality of branches to produce a plurality of outputs for the plurality of branches. Each branch is a separate and independent network that receives input from the single standard convolution layer. The method further includes steps for passing the plurality of outputs through a supervisor layer that combines the plurality of outputs into a final solution.

### CROSS-REFERENCE TO RELATED APPLICATIONS

The current application claims the benefit of and priority under 35 U.S.C. § 119(e) to U.S. Provisional Patent Application No. 62/648,344 entitled “Systems and Methods for Generative Ensemble Networks” filed Mar. 26, 2018. The disclosure of U.S. Provisional Patent Application No. 62/648,344 is hereby incorporated by reference in its entirety for all purposes.

### FIELD OF THE INVENTION

The present invention generally relates to generative machine learning models and, more specifically, generative ensemble networks.

### BACKGROUND

Deep neural networks have been responsible for many of the recent breakthroughs in machine learning and computer vision. The ability to train far deeper networks has been a key component of this. Larger, deeper networks can allow for better function approximation, but can become increasingly difficult to train.

### SUMMARY OF THE INVENTION

Systems and methods for training a generative ensemble network to generate image data in accordance with embodiments of the invention are illustrated. One embodiment includes a method for generating an image through an ensemble network architecture. The method includes steps for passing a set of one or more images through a single standard convolution layer that acts as a root node to produce a first output and passing the first output through a plurality of branches to produce a plurality of outputs for the plurality of branches. Each branch is a separate and independent network that receives input from the single standard convolution layer. The method further includes steps for passing the plurality of outputs through a supervisor layer that combines the plurality of outputs into a final solution.

In a further embodiment, the supervisor layer combines the plurality of outputs by summing the plurality of outputs.

In still another embodiment, the supervisor layer combines the plurality of outputs by concatenating the plurality of outputs.

In a still further embodiment, the supervisor layer combines the plurality of outputs by delegating the outputs from each individual branch. The combined output has a different width and height as the last layer in each of the plurality of branches.

In yet another embodiment, the ensemble network architecture is for performing single image super resolution (SISR) for an input image. The plurality of branches includes N2 branches, where N is the upscaling factor, each branch shares a same architecture, and the supervisor layer delegates features, wherein the N2 branches are repositioned along the width and height axes of the supervisor layer.

In a yet further embodiment, the method further includes correcting visual artifacts resulting from the SISR process by taking a neighborhood of pixels from each branch of the plurality of branches, wherein each neighborhood of pixels is derived from a corresponding low resolution pixel, computing a delta for each neighborhood of pixels with respect to the corresponding low resolution pixel, and applying a resulting transformation directly to the output of the supervisor layer.

In another additional embodiment, each branch of the plurality of branches utilizes a dilated architecture.

In a further additional embodiment, a first branch has a first degree of network capacity and each subsequent branch of the plurality of branches exhibits an increasing degree of network capacity from the previous branch.

In another embodiment again, the method further includes training the ensemble network architecture in a cascaded manner, wherein branches of the plurality of branches are trained sequentially from lower network capacity to higher network capacity.

In a further embodiment again, training further includes training all of the branches in a single pass.

In still yet another embodiment, the ensemble network architecture further includes a discriminator network, wherein the method further comprises passing the final solution through a second single standard convolution layer that acts as a root node of the discriminator network to produce a second output, passing the second output through a second plurality of branches to produce a second plurality of outputs, wherein each branch is a separate and independent network that receives input from the second single standard convolution layer, and passing the second plurality of outputs through a second supervisor layer that combines the second plurality of outputs into a second final solution.

In a still yet further embodiment, the discriminator network is stored and used during inference.

In still another additional embodiment, the result of N branches of the discriminator network is used as an input to the N+1 branch of the generator network.

In a still further additional embodiment, the discriminator network includes a plurality of discriminators for the plurality of branches, wherein the result of a set of one or more discriminators of the plurality of discriminators is used as an input to a next branch of the plurality of branches.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an example of a GEN architecture in accordance with an embodiment of the invention.

FIG. 2 illustrates an example of a multi-capacity GEN architecture in accordance with an embodiment of the invention.

FIG. 3 illustrates an example of a GEN with a discriminator network in accordance with an embodiment of the invention.

FIG. 4 illustrates an example of an ensemble architecture with an ensemble discriminator network in accordance with an embodiment of the invention.

FIG. 5 illustrates an example of an ensemble network architecture for image super resolution in accordance with an embodiment of the invention.

FIG. 6 illustrates an example of a system that provides a system that can train a generative ensemble network and generate image data in accordance with an embodiment of the invention.

FIG. 7 illustrates an example of a processing system in a device that executes instructions to perform processes that can train a generative ensemble network and/or generate images in accordance with an embodiment of the invention.

FIG. 8 conceptually illustrates a process for training a generative ensemble network in accordance with an embodiment of the invention.

FIG. 9 conceptually illustrates a process for generating an image with a generative ensemble network in accordance with an embodiment of the invention.

FIG. 10 conceptually illustrates a process for generating an image with a generative ensemble network and a discriminator ensemble network in accordance with an embodiment of the invention.

### DETAILED DESCRIPTION

Turning now to the drawings, systems and methods in accordance with some embodiments of the invention provide a novel, general purpose, image-to-image generative neural network method that is based on collections of shallow networks cooperating as an ensemble.

The strategy of adding more residual blocks as a general purpose method for improving network performance of any task is increasingly common. However, it is unclear whether problems arising with such deep networks, such as vanishing gradients and shattered gradients, are in fact problems that need to be solved, or perhaps an indication that simply adding more layers to a network is ill-suited to the problem of learning increasingly complex functions. Deep residual networks are often unable to effectively propagate gradient through a deep network as the depth of the network increases. Vanishing gradients result from the exponential decay of the gradient as the depth of the network increases. Similarly, shattered gradients result in gradients that increasingly resemble white noise as the depth of the network increases.

Other methods such as residual neural networks (RNNs) implement skip connections to alleviate some of these difficulties with the gradients decaying, making training possible. Skip connections in RNNs can dramatically reduce the effective length, leaving significant unused or redundant capacity. In this manner, RNNs do not solve the vanishing or shattered gradient problems but instead avoid aspects of the problem by introducing short paths which carry gradient throughout the network. Ensemble approaches in accordance with many embodiments of the invention can be more effective than an unrolled RNN as well as more principled. The nature of an ensemble network is analogous to a Gaussian mixture model, with each branch being responsible for varying levels of detail.

In numerous embodiments, systems and methods can expand upon a discriminating ensemble network strategy for the purposes of generation. In many cases, a correct degree of network capacity is more important for generation than for classification/discrimination. While a neural network defines a non-linear continuous transformation function, for the purposes of discrimination, this function is ultimately binned into a discrete and finite set of values. This lack of precision is forgiving towards under-fitting and over-fitting. In contrast, generation quality is directly bound to proper network capacity.

Network capacity can be determined by the degree of complexity of the data itself and real world data is highly heterogeneous. Put in layman's terms, an image, video sequence, audio clip, 3D model or any type of multimedia data passed through a neural network will typically consist of several different functions stitched together across dimensions (i.e., space and time) with different degrees of complexity in different localized regions. Thus, it is difficult for a single network architecture to simultaneously exhibit ideal capacity across the entire function. Rather, deep networks lead to a compromise that optimizes for best performance across an average of the space, at the sacrifice of optimizing any one region of the space. Ensemble networks in accordance with some embodiments of the invention are therefore uniquely well suited to this problem. Rather than a single “one size fits all” network, ensemble networks in accordance with a variety of embodiments of the invention can offer a set of branched networks of varying capacity. In a number of embodiments, branched networks can be individually optimized for different functions. Individual branches in accordance with numerous embodiments of the invention can work together to find a more optimal solution.

In several embodiments, a general purpose generative ensemble network (GEN) architecture can be used to solve a wide range of image-to-image translation problems. Ensemble networks in accordance with some embodiments of the invention can be trained using a set of one or more general purpose loss functions for training GENs. Alternatively, or conjunctively, GENs in accordance with some embodiments of the invention can be trained using application specific loss functions. GEN architectures in accordance with several embodiments of the invention can outperform popular deep residual strategies, in direct contrast to the widely accepted belief that “deeper is better”.

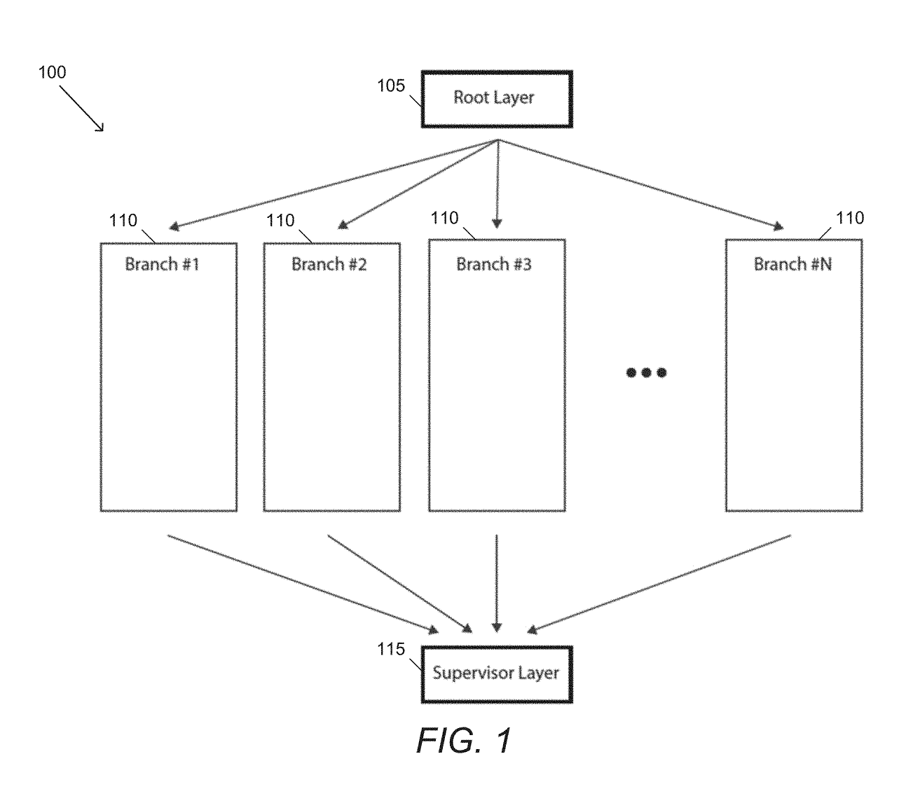

Systems and methods in accordance with certain embodiments of the invention implement a Generative Ensemble Network (GEN) architecture. In many embodiments, a GEN architecture can be characterized by an initial, common (or root) layer, two or more “branches”, and a supervisor layer. An example of a GEN architecture is illustrated in FIG. 1. In this example, architecture 100 includes a root layer 105, multiple branches 110, and a supervisor layer 115. Root layers in accordance with several embodiments of the invention can be a single standard convolution layer that acts as a root node in the networks dependency graph.

In numerous embodiments, each branch can be a separate and independent network. A single GEN architecture can include branches that differ in a number of different ways, including (but not limited to) different network types, different numbers of layers, different hyperparameters, different outputs, etc. Each branch receives an input from a root layer and sends an output to a supervisor layer. Supervisor layers in accordance with some embodiments of the invention can gather the outputs from each of the branches and distills this information into a final solution.

In certain embodiments, each of the various branches can attempt to solve some part of the overall problem in its own way. Supervisor layers in accordance with several embodiments of the invention can determine how a global problem is delegated among the branches and can make a final decision on how the different branched solutions will be consolidated into a final transformation. In a number of embodiments, consolidating the outputs of the multiple branches in order to make a final decision can include (but is not limited to) summation, feature concatenation, and feature delegation.

In various embodiments, the summation of multiple branches can add the activation responses from all branches together. This is essentially taking the average opinion from all the branches. When performing summation in accordance with several embodiments of the invention, the activation values from the last layer in each branch can be averaged into a single mean. As such, when performing summation, processes in accordance with certain embodiments of the invention do not run an activation function over the last convolution layer in each branch, but rather sum them together and then run the activation function over the final summation.

In numerous embodiments, feature concatenation can concatenate the final activation vectors from every branch into a single layer. This offers the advantage that the supervisor layer can learn how to choose the best values among the different branches, to solve the problem at hand.

Feature delegation in accordance with various embodiments of the invention is similar to feature concatenation. Both strategies can retain all final branch outputs in the supervisor layer. Concatenation in accordance with many embodiments of the invention can maintain the width and height of the branch outputs while increasing the depth to combine all the individual branch output channels. Feature delegation in accordance with many embodiments of the invention maintains the same layer depth as the branch outputs but increases the width and/or height to combine all the pixels from the various branches in some new combined ordering. In a number of embodiments, feature delegation allows the supervisor layer delegates different aspects of the problem to different branches. Instead of all the branches working to solve the same problem together through committee, they can each specialize in a separate part of the problem and their solutions are combined into a full solution. Feature delegation can be particularly useful in a number of applications, such as (but not limited to) single image super resolution (SISR).

In some embodiments, the resulting output of a supervisor layer can be used as an input to another network. The network in accordance with numerous embodiments of the invention can be used for a variety of purposes, including (but not limited to) generating an image, classifying an input image, etc.

### Multi-Capacity GENs

Branches of a GEN in accordance with a variety of embodiments of the invention can be any arbitrary architecture, allowing GENs to be a flexible and general purpose network strategy. In various embodiments, a specific multi-capacity form of GEN is utilized to behave in a similar manner a residual network, while achieving superior performance.

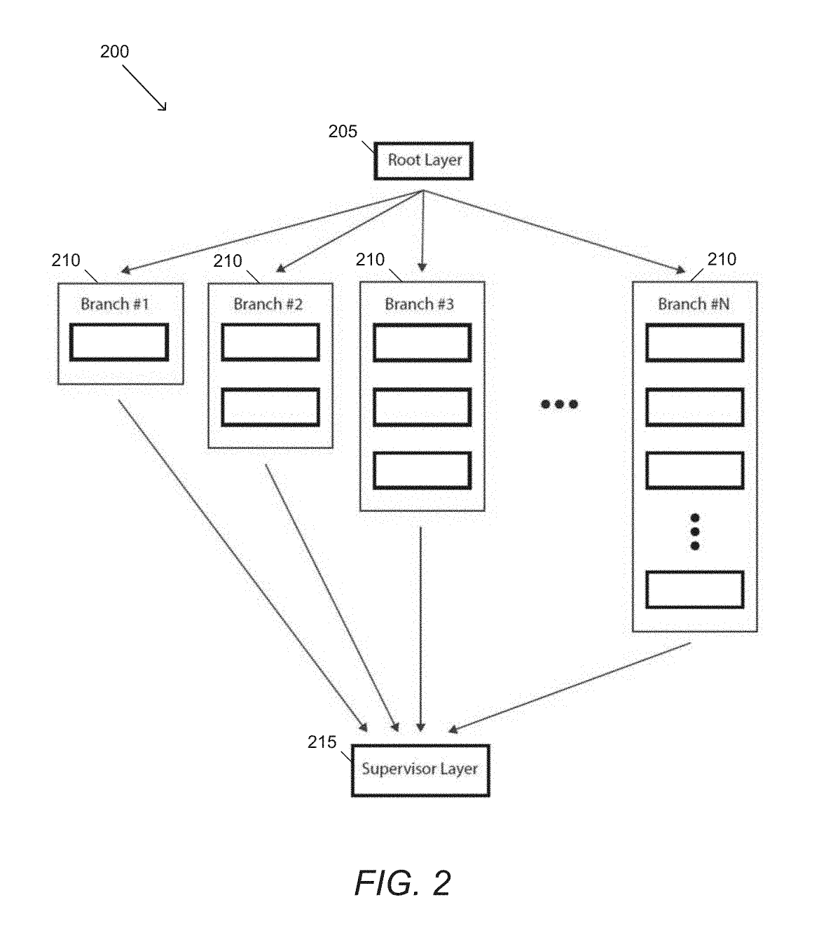

In many embodiments, an initial branch of an N branched multi-capacity network has a relatively low capacity, while each subsequent branch has a higher degree of capacity than a previous branch. In this way, GENs can implement different capacity or length branches. In some embodiments, GENs can utilize a chain of standard convolution layers in each branch. An example of a multi-capacity GEN is illustrated in FIG. 2. In this example, GEN 200 includes root layer 205, branches 210, and supervisor layer 215. However, unlike the previous example, each branch 1-N has an increasing number of layers. Although this example illustrates branches with an increasing number of layers, other methods of increasing capacity (such as, but not limited to, increasing filter depths, increasing receptive fields, introducing dilation, etc.) can also be used in accordance with several embodiments of the invention. Increasing capacity in accordance with certain embodiments of the invention can include any strategy that increases the number of neurons and/or the number of connections between neurons.

Dilation is a strategy for down-sampling without sub-sampling. This allows the network to increase its receptive field without losing layer resolution or fidelity. Many applications rely on large receptive fields in order to capture global structures or characteristics of an image. Many deep architectures achieve this through the virtues of being deep. Because ensemble networks in accordance with certain embodiments of the invention can contain a set of relatively shallow networks, dilation offers a viable alternative strategy for capturing a large receptive field within a shallow network.

### Loss Functions

A variety of different loss functions (and combinations of loss functions) can be used to train a generative ensemble network in accordance with a variety of embodiments of the invention. In various embodiments, a loss function can be made up of a combination of three standard strategies, each of which offer a unique and consistent benefit across a wide range of image generation applications. Such a loss function can be written as:

l=l_{MSE}+l_{PER}+|l_{GAN}

In this example, the first term (I_{MSE}) is a per-pixel loss between the output and ground-truth images. A mean squared error (MSE) loss can be calculated as:

$${l}_{MSE} = \frac{1}{{r}^{2} WH} {\sum }_{{x}_{0} = 1}^{rW} {\sum }_{{x}_{1} = 1}^{rH} {( {I}_{{x}_{0} , {x}_{1}}^{T} - {G}_{{θ}_{G}} ( {I}_{{x}_{0} , {x}_{1}}^{I} ) )}^{2}$$

where G_{θ}_{_{G}} is our generator network parameterized by θ_{G}={W_{1:L};b_{1:L}}, I^{I} denotes the input image, I^{T} denotes the target image, r is the stride, W is the width and H is the height. MSE can be an intuitive way of quantifying the difference between two images, but can do a poor job of quantifying the difference in human perception. For example, consider two identical images that have been transposed by a single pixel, or two nearly identical images where one image is a single bit darker than the other. Despite being perceptually indistinguishable from each other, both cases would result in a large error as measured by MSE. In a number of embodiments, l^{T} and generated images l^{G} can be blurred by some degree, in order to make the MSE somewhat invariant to imperceptible variations at the per-pixel level.

High-level image features can be encoded in deeper layers of pre-trained convolutional neural networks designed for image discrimination. In several embodiments, high-quality images can be synthesized by minimizing a “perceptual loss” l_{PER}, or the L2 distance between these neural activations, rather than the low-level pixel based MSE. In some embodiments, loss functions can utilize extended versions of perceptual loss that utilize pre-activation layer values combined with contextual matching.

In addition to MSE and perceptual loss, loss functions in accordance with numerous embodiments of the invention can include an adversarial loss. The added precision in capacity resulting from the ensemble network design in accordance with a variety of embodiments of the invention can benefit from the extra degree of precision achieved through adversarial training.

### Training Strategies

Ensemble frameworks in accordance with some embodiments of the invention are versatile and can provide a high degree of flexibility when choosing a training strategy. In certain embodiments, the GEN architecture can be simply trained as a whole. Given an image pair: [Input, Target], an input can be fed into the network and a generated output can be read as output from the network. Processes in accordance with certain embodiments of the invention can use the [Generated, Target] pair as the training pair used by a loss function in order to calculate a gradient.

In several embodiments, adversarial training can implement a relativistic discriminator for stable and high quality adversarial training of the generative ensemble structure. Relativistic training provides a generator with gradient from the real data in addition to just the generated data as in the standard approach. In many embodiments, relativistic training determines an average realness and fakeness for a batch of images and attempts to calculate whether an individual image is more real than the average of fakes and less real than the average of reals. This stabilizes adversarial training while also producing higher degrees of realism in the generated output.

While adversarial training has become standard for generative image problems and image-to-image translation, it requires additional discussion and consideration due to its invasive requirement of adding a second network to the system that must also be trained. Additionally, orthogonal to the established adversarial training methods, the ensemble architecture can be used to improve the standard discriminator network architecture, a topic which also warrants description.

A typical discriminator network architecture is comprised of dithered, strided and regular convolution layers, gradually increasing the number of layer channels (e.g., from 64 to 512) before a final tan h activated densely connected layer. In some embodiments, discriminators are implemented with an ensemble structure to mimic the generator. This ensemble based discriminator can slow down training, but can increase the effectiveness of the adversarial loss component, leading to better final results. Discriminators in accordance with a variety of embodiments of the invention can be composed of an ensemble architecture mimicking the generator, ending in dithered strided and unstrided convolutions (e.g., of size 256 and 512) and finally the dense layer output, taken directly from the established discriminator approach.

In various embodiments, when training a multi-capacity ensemble network, a particular behavior is observed. This behavior justifies a modification to the training strategy used for multi-capacity ensembles. It is observed that when a multi-capacity network is trained using the basic training approach, the different branches naturally begin to specialize at generating image features that exhibit a complexity on par to that branches network capacity. In the case that a multi-capacity GEN has four branches ranging from one to four stacked convolution layers, it is observed that the first branch, when inferred in isolation from the others, will produce a blurry version of the final image, containing the majority of the color information. When the first two branches are run together, the image becomes sharper with large simple edges beginning to emerge. As more, deeper branches are added progressively, finer details can appear and eventually texture emerges in the final image.

However, this behavior can be approximate and unreliable. When all branches are trained in parallel, each branch can get pushed into its own local minimum due to the influence of other branches, which can lead to branches fighting each other to some degree, rather than specializing on part of the solution and working together. It is often desirable to segregate the encoding of color information and to optimize the influence of the individual branches.

To coerce the network to find a more global minimum and thus exhibit more desirable behavior, processes in accordance with several embodiments of the invention implement a cascaded training strategy, where branches are trained sequentially rather than in parallel. This can be especially suitable for the multi-capacity form of the GEN where the branches are sequentially trained from smallest to largest. This can lead to more ideal behavior where each branch introduces a new higher fidelity layer of features than were learned by the previous, smaller layers. In addition, color shifts can be kept to a minimum. In certain embodiments, supervisor layers for a multi-capacity network that is being trained sequentially are summation layers. In several embodiments, when performing a summation supervisor layer, the activation function is not run on the last layer of each branch but rather on their summation. This can lead to the first branch producing a blurry version of the final image with each subsequent branch learning offsets from that signal and then from the summation of offsets to that signal when multiple branches are involved. In many embodiments, each branch can learn how to modify the previously summed branches in order to add new, finer scale details that were not possible to learn with the previous branch's lower degree of capacity.

In some embodiments, a basic training can be performed in conjunction with cascaded training, whether before, after, or dithered in-between. Basic training beforehand can be used to coarsely align all the branches together before being refined by the cascaded training. Basic training after the process can help modify the branches that were run early in the sequence to better bootstrap the branches later in the sequence.

Adversarial Ensembles with Cascaded Feedback

In various embodiments, training of an ensemble network can use cascaded feedback. During cascaded training, a discriminator can continuously train itself to discern whether an image is real or a fake produced by the generator network. Discriminators in accordance with some embodiments of the invention can continuously learn to recognize visual mistakes or insufficiency in the generated image. When performing cascaded training of a multi-scale generative network in accordance with many embodiments of the invention, the shallow branches can first learn to generate a low fidelity image and the deeper branches can refine the image adding higher frequency details.

Image generation is an interesting class of problem due to the fact that image data rarely contains the same degree of complexity homogeneously across the entire image. For example, a photograph of a house on a grassy field with a blue sky in the background will contain three distinct regions that contain three different degrees of image/feature complexity. The blue sky is a flat color with very low complexity that can be learned with shallow branches of the network. The house contains sharp edges and architectural structures that must be learned by deeper branches in the network. Likewise, the grass and vegetation exhibits a high degree of fine detail texture, another category of feature that must be learned by the deeper branches in the ensemble.

The typical adversarial training approach utilizes a discriminator which ends with fully connected layers that produce a single 0-1 probability score that the input image is real vs. fake. Discriminators in accordance with many embodiments of the invention can assign a realness score to individual regions of an image. Because multi-capacity ensemble networks result in each branch specializing to some degree at producing certain image features and because cascading training can reinforce this behavior, such discriminators can further reinforce the behavior that each branch specializes on a sub-part of the image generation task.

In a variety of embodiments, a generative ensemble network includes a discriminator network that can be used for inference as well as for training. Discriminators in accordance with some embodiments of the invention can effectively produce a heat-map for how real vs. fake each region of a generated image is. When performing cascaded training in accordance with several embodiments of the invention, discriminator heat-maps produced by the previous branches can be used as input to the current branch being trained. This can tell the current branch where the image is already very real and where it still requires improvement. This information can help the current branch to specialize on improving specific image dependent locations in addition to the specific feature frequency and complexity it would otherwise learn. Building on the previous example of the house on a field with a blue sky in the background, the shallow branches can learn the blue sky first. The discriminator heat-map can then tell the later branches to ignore this region of the image and instead focus on the areas that need improvement the most. In this manner, the branch neurons will be trained more effectively than with standard cascaded training.

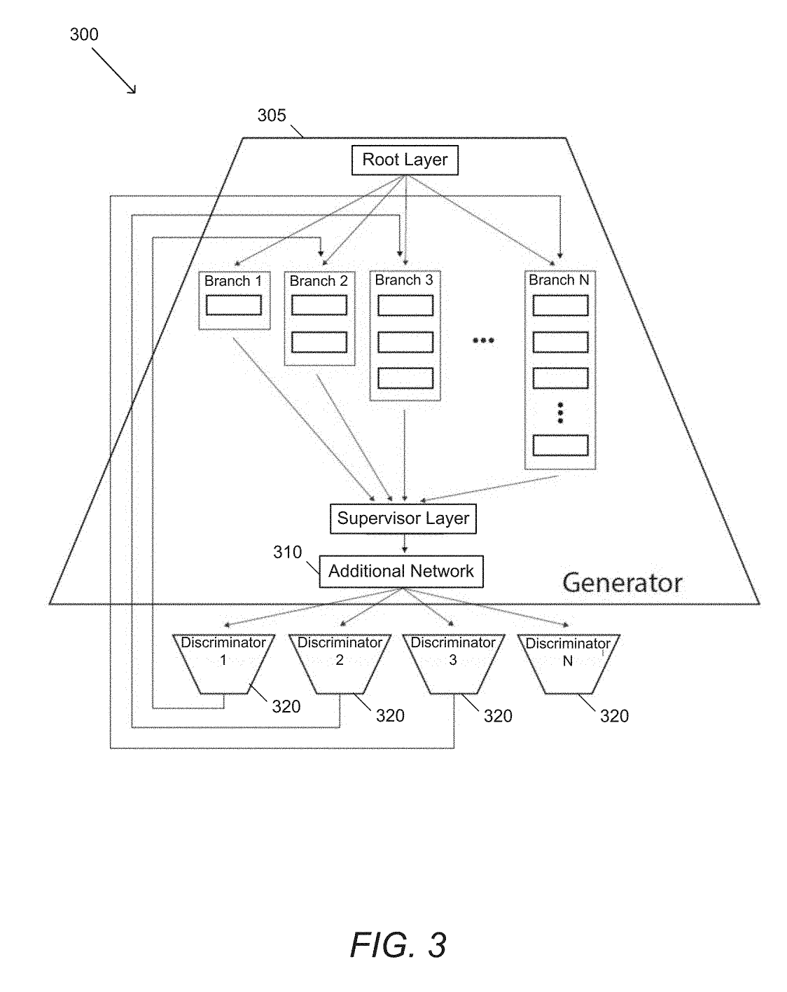

An example of a GEN with a discriminator network is illustrated in FIG. 3. Discriminator network 300 includes a multi-capacity generator network 305 and a series of discriminators 320. Generator network 305 includes additional network 310. Additional networks can include a number of different networks, such as (but not limited to) convolutional neural networks, recurrent neural networks, and other ensemble networks. In certain embodiments, there is an additional network prior to the root layer of a GEN. GENs in accordance with several embodiments of the invention can be a block within a larger, overall network. In many embodiments, no additional network is included.

In this example, the outputs of each branch can be used to train a corresponding discriminator. The outputs of each discriminator can then be fed into a next branch to help it specialize on the regions of the image that need the most improvement. In many embodiments, the first branch of the generator network is trained based on the outputs of the first branch of the discriminator. The outputs of the first branch of the discriminator can also be used to train the second branch of the generator network in accordance with many embodiments of the invention.

Reinforcing cascaded training with discriminator heat-maps can introduce a significant drawback in that an entire discriminator network must be trained and stored for each branch (apart from the final branch). This can introduce a drastic increase in model size and network complexity. Ensemble architectures can be further utilized as an elegant solution to this drawback. Rather than a single deep chain of layers, processes in accordance with many embodiments of the invention can use an ensemble network with the same number of branches as the generator. Discriminator ensemble networks in accordance with numerous embodiments of the invention can be multi-capacity. In a variety of embodiments, during training, each discriminator branch can be trained in tandem with a corresponding generator branch. In numerous embodiments, each discriminator branch can contribute to the combined opinion of the previous branches. Summation supervisor layers in accordance with some embodiments of the invention can be used to consolidate the final result. In this way, discriminators can be trained using the same cascading strategy as the generator.

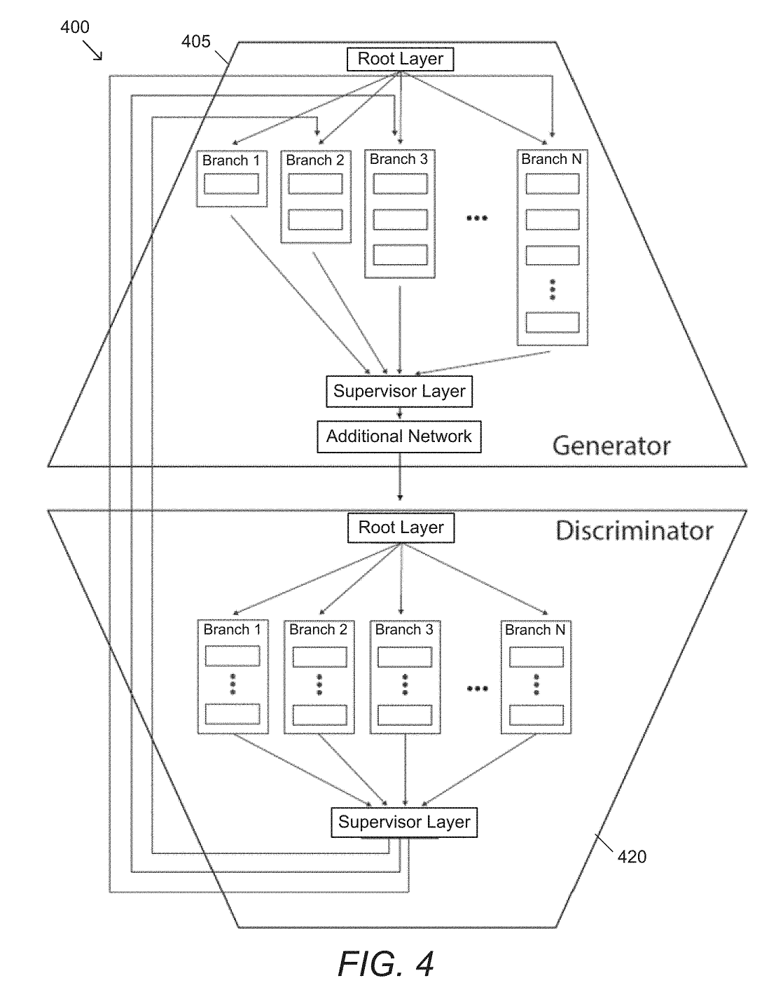

An example of an ensemble architecture with an ensemble discriminator network is illustrated in FIG. 4. Ensemble discriminator networks can take advantage of the ensemble architecture to progressively improve image discrimination with each additional branch, in tandem with the generator's ability to improve the perceptual quality. In numerous embodiments, both can be trained in a cascaded manner. In this example, generative ensemble network 400 includes an ensemble generator 405 and an ensemble discriminator 420. Ensemble generator 405 is a multi-capacity ensemble network. Ensemble discriminator 420 includes an ensemble network with a same number of branches as ensemble generator 405.

Generative ensemble networks have proven to be extremely versatile for problems involving image-to-image translation. There are several open image enhancement problems in the area of computer vision that can benefit from ensemble networks.

### Single Image Super Resolution

The single image super resolution problem aims at restoring an original image from a downscaled version of itself. CNN based solutions have achieved top performance for this application. Network ensembles in accordance with many embodiments of the invention can provide a superior alternative to both the deep residual architecture as well as the pixel-shuffle method that is widely followed today.

The nature of ensemble networks make them particularly well suited to the problem of Single Image Super Resolution (SISR). Ensemble networks provide a powerful alternative to the deep residual architecture as a means of learning ideal network capacity. This can be especially relevant to the problem of SISR where large image features can have varying degrees of complexity and the fine scale textures to be hallucinated over those features can also have varying degrees of complexity.

Ensemble networks in accordance with some embodiments of the invention can offer distinct advantages over pixel-shuffle. For example, ensemble branches can contain multi-layer networks. This extra modeling power is not possible in the pixel-shuffle framework. In addition, supervisor layers can be tailored to the problem at hand. While pixel-shuffle simply re-positions neurons, supervisor layers in accordance with certain embodiments of the invention can take a neighborhood of pixels from its branch into account when choosing a final value. These distinctions can lead to an increase in modeling power and can avoid the common “checkerboard artifact” caused by the pixel-shuffle layer.

In various embodiments, when performing image super resolution, ensemble networks can utilize the same architecture for every branch, and can use a supervisor layer that delegates features where N² (N>1) branches are repositioned along the width and height axes based on the following equation: Branch b=w % N+(h % N)*N.

Processes in accordance with some embodiments of the invention can avoid the common “checkerboard” and color shift artifacts by taking a neighborhood of pixels from each branch, computing their delta with respect to the lower res pixel they are upscaling, averaging these deltas together, and applying them to the low res pixel that the current sample is upscaling.

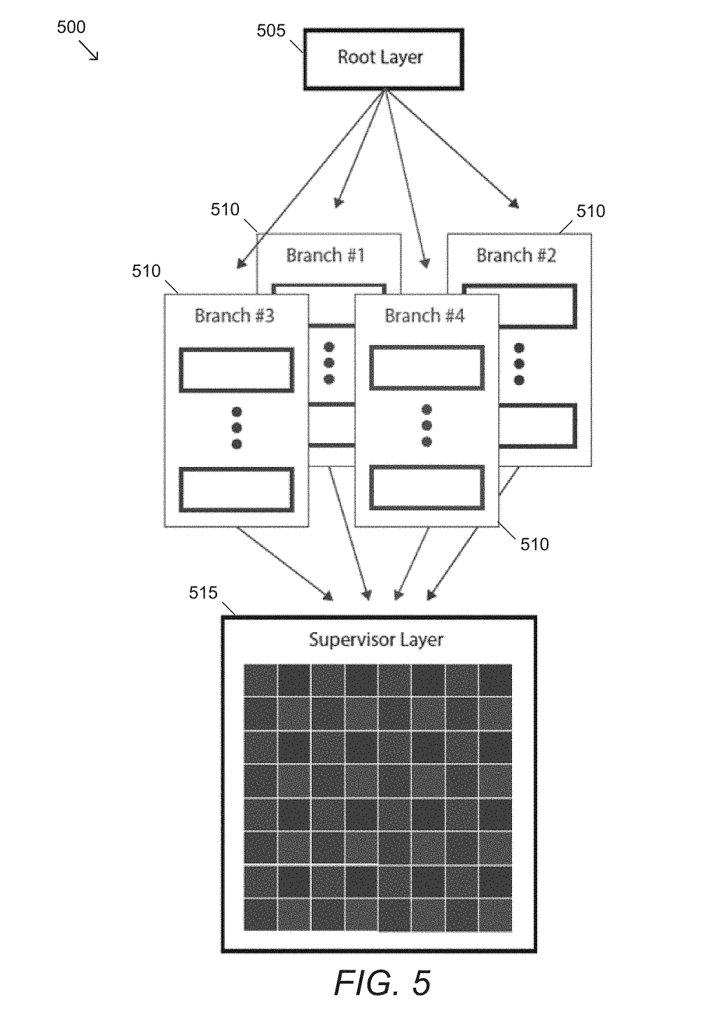

An example of an ensemble network architecture for image super resolution is illustrated in FIG. 5. In this example, root layer 505 provides an input to multiple branches 510. Each branch then feeds into a supervisor layer 515 that can upres pixels of an input based on a neighborhood of pixels from each branch of the architecture.

EXR format presents a number of new challenges for Super Resolution. In a number of embodiments, in order to operate with HDR data, methods for adapting 8-bit data were utilized. In addition to the challenge of increased bit depth, EXR uses custom colour channels and logarithmic scaling. In several embodiments, images are first re-scaled to have strictly positive values by adding the min pixel value and a small constant term. In a variety of embodiments, the image is converted to log space before finally normalizing the image between −1 and 1 for processing. The inverse transformations are then applied on the other side returning the image to the same colour space and scale.

### Compression Artifact, Grain, Noise Removal

Image and video compression algorithms are commonly used to reduce the size and dimension of media files, reducing their disk space requirements and transmission time. Most of these algorithms are lossy and often introduce compression artifacts such as ringing, contouring, posterizing, aliasing and blocking. Typically, as in the case of JPG, the larger the compression factor, the more severe the image degradation and artifacts become. Many methods used to treat the problem of compression artifact removal are signal processing based. These range from techniques from using joint statistical models based on inpainting to optimizing discrete cosine transform coefficients, and have only recently included machine learning based methods RNNs based GANs. Similarly, photographic noise caused by low-lighting conditions and film grain removal follows a similar algorithmic history as compression artifact removal, early solutions were based on signal processing with a recent shift to CNNs, Residual and RNNs have achieved state of the art results.

These three problems are highly related to each other. They all focus on repairing small damaged regions of an image that involve some undesirable high frequency feature. This problem is also well suited to the GEN architecture in accordance with a variety of embodiments of the invention. By training on lower quality JPG and the ground truth, or noisy/grainy with clean, ensemble networks in accordance with various embodiments of the invention can recover detail lost during compression and ameliorate artifacts created in low quality JPG images. For example, a JPG trained network was able to produce images with more photorealistic features on a wide range of compression types: JPG, video intra-frame coding such as H.264/AVC and H.265/HEVC. These algorithms typically work in the YCrCb color space to separate luminance from chrominance information and sub-sample chrominance to make the visual changes less obvious. Processes in accordance with many embodiments of the invention convert the training images to YCrCb before a set of their compressed counterparts are generated.

In certain embodiments, processes can use an image gradient loss that is particularly well suited to the problem of high-frequency artifact removal problems. Image gradient loss is a per-pixel loss similar to MSE but sampled from a transform of the image for emphasizing edges within a loss function. Transforms in accordance with certain embodiments of the invention can include (but are not limited to) the sobel transform and the High Frequency Error Norm.

In a number of embodiments, the multi-capacity network architecture can be used for artifact removal with a large receptive field (e.g., 15×15) for the first layer in each branch as well as the final layer. A smaller receptive field (e.g., 3×3) can then be used for the remaining convolutional layers. In numerous embodiments, a summation or concatenation supervisor layer can be used, followed by some number (e.g., three) of additional convolutional layers.

### Image Deblurring

Image deblurring can be performed using signal processing and with the addition of accelerometer data. However the problem of blind image deblurring is a more ill-posed. The most common techniques again rely on signal processing methods such as DCT, linear models or statistical approaches incorporating edge detection. Recently, attempts have been made to apply neural networks to this problem by using them to predict the complex Fourier coefficients of a deconvolutional filter applied to the image.

In a variety of embodiments, an ensemble network is trained on images with random levels of Gaussian blur applied and their originals. Using a range of blur levels was found to make the network more robust for real world data. Instead of estimating Fourier coefficients the GEN was applied directly to the image.

### Image Colorization, Tone Mapping and SD to HDR Conversion

Arbitrary image-to-image color transforms can be generalized with a single GEN network strategy, with specific use cases being learned from the training set. In a variety of embodiments, GENs in accordance with numerous embodiments of the invention can be used in a variety of use cases, including (but not limited to), adding color to a black and white image, improving the tone of washed out images, and increasing the bit depth of colors from standard definition (8 bits per color) to high dynamic range (10, 16 or 32 bits per color channel).

Multi-capacity ensemble networks in accordance with various embodiments of the invention with a summation or concatenation supervisor layer has proven very effective. In several embodiments, multi-capacity ensemble networks can include three additional convolution layers following the supervisor layer and a network-wide, per-layer depth of 64 channels. In certain embodiments, processes can modify the MSE loss function by applying a Gaussian blur over the network output and ground truth images before computing the per-pixel loss. MSE loss is responsible for learning the mapping between color spaces. Noise and small image translations can have a large and undesirable impact on the MSE loss which is ameliorated through Gaussian blur.

### Monocular Single Image Depth Map Estimation and Image Dehazing

Monocular depth map estimation and image dehazing belong to a class of image-to-image generation problems where the goal is to generate a completely different image that offers insights or extra information about the image itself. Depth estimation attempts to guess the distance between the camera and each point in the image on a per-pixel level of detail by learning to recognize visual clues from the image. Haze in a photograph is caused by dust and water particles in the atmosphere obstructing or scattering light. Dehazing an image involves estimating both the depth map as well as the type and degree of atmospheric particles. With these two pieces of information, a haze map can be synthesized; when subtracted from the hazy image it can produce a clean one. The problem of dehazing is thus the problem of synthesizing a haze. There are other open problems within this category, such as extracting material reflectance properties from a single image.

To address these use cases, GENs in accordance with a variety of embodiments of the invention can stack two GENs in sequence, where the output of the first GEN becomes the input layer for the second GEN, concatenated with the original image. The first GEN could then exhibit a larger receptive field than the second GEN.

In problems such as these, estimating correct values for the global structure of the image is typically more important than local accuracy. Processes in accordance with several embodiments of the invention can use three standard convolutional layers in one or more of the branches. Alternatively, or conjunctively, processes in accordance with many embodiments of the invention can repeatedly chain pooling (e.g., 2×2), immediately followed by a deconvolution layer which increases the non-linearly of the network leading to superior results. In some embodiments, processes can use three layer blocks consisting of a 2×2 pooling layer followed by a deconvolution layer followed by a standard convolution layer in one or more of the branches.

While specific implementations of ensemble networks have been described above with respect to FIGS. 1-5, one skilled in the art will recognize that various configurations of ensemble networks can be implemented as appropriate to the requirements of a given application.

### Generation System

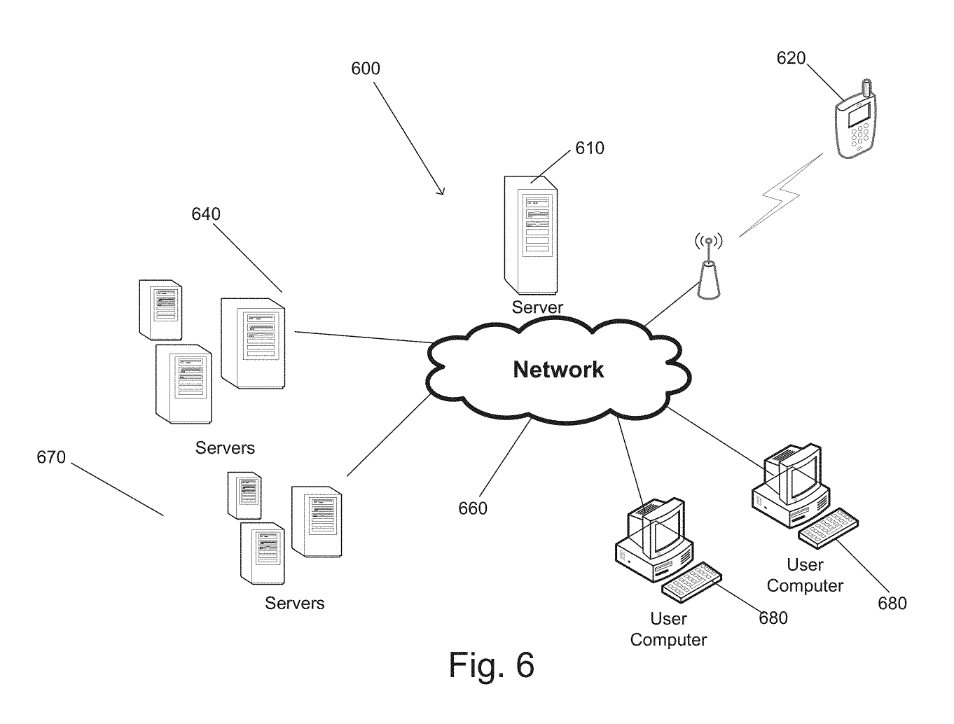

A system that provides a system that provides can train a generative ensemble network and generate image data in accordance with some embodiments of the invention is shown in FIG. 6. Network 600 includes a communications network 660. The communications network 660 is a network such as the Internet that allows devices connected to the network 660 to communicate with other connected devices. Server systems 610, 640, and 670 are connected to the network 660. Each of the server systems 610, 640, and 670 is a group of one or more servers communicatively connected to one another via internal networks that execute processes that provide cloud services to users over the network 660. For purposes of this discussion, cloud services are one or more applications that are executed by one or more server systems to provide data and/or executable applications to devices over a network. The server systems 610, 640, and 670 are shown each having three servers in the internal network. However, the server systems 610, 640 and 670 may include any number of servers and any additional number of server systems may be connected to the network 660 to provide cloud services. In accordance with various embodiments of this invention, a generative ensemble network that uses systems and methods to train the network and/or to generate images in accordance with an embodiment of the invention may be provided by a process being executed on a single server system and/or a group of server systems communicating over network 660.

Users may use personal devices 680 and 620 that connect to the network 660 to perform processes for providing and/or interaction with a generative ensemble network that uses systems and methods to train a generative ensemble network and/or to generate images in accordance with various embodiments of the invention. In the shown embodiment, the personal devices 680 are shown as desktop computers that are connected via a conventional “wired” connection to the network 660. However, the personal device 680 may be a desktop computer, a laptop computer, a smart television, an entertainment gaming console, or any other device that connects to the network 660 via a “wired” connection. The mobile device 620 connects to network 660 using a wireless connection. A wireless connection is a connection that uses Radio Frequency (RF) signals, Infrared signals, or any other form of wireless signaling to connect to the network 660. In FIG. 6, the mobile device 620 is a mobile telephone. However, mobile device 620 may be a mobile phone, Personal Digital Assistant (PDA), a tablet, a smartphone, or any other type of device that connects to network 660 via wireless connection without departing from this invention.

### Generation Element

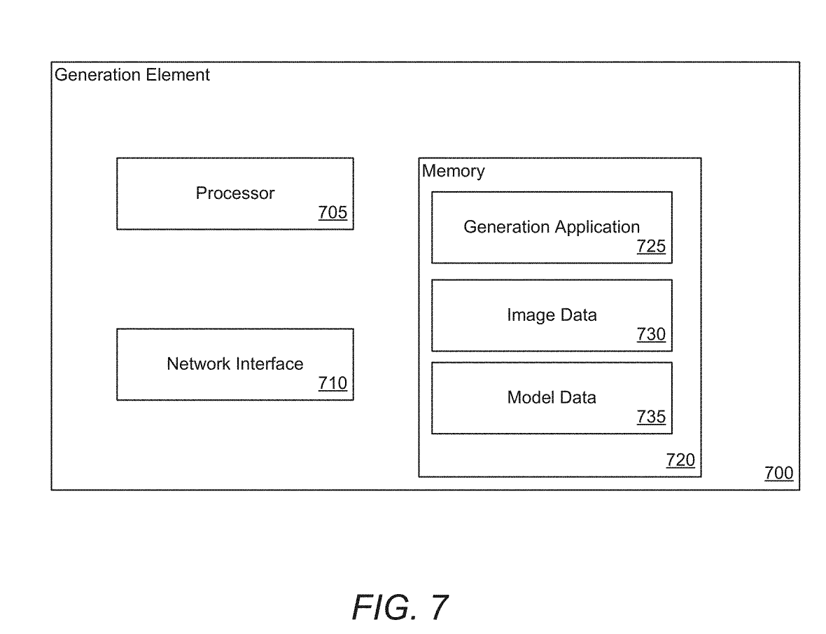

An example of a processing system in a device that executes instructions to perform processes that can train a generative ensemble network and/or generate images in accordance with various embodiments of the invention is shown in FIG. 7. Generation elements in accordance with many embodiments of the invention can include (but are not limited to) one or more of mobile devices, servers, and other computing elements. Generation element 700 includes processor 705, network interface 710, and memory 720.

One skilled in the art will recognize that a particular generation element may include other components that are omitted for brevity without departing from this invention. The processor 705 can include (but is not limited to) a processor, microprocessor, controller, or a combination of processors, microprocessor, and/or controllers that performs instructions stored in the memory 720 to manipulate data stored in the memory. Processor instructions can configure the processor 705 to perform processes in accordance with certain embodiments of the invention. Network interface 710 allows generation element 700 to transmit and receive data over a network based upon the instructions performed by processor 705.

Memory 720 includes a generation application 725, image data 730, and model data 735. Generation applications in accordance with several embodiments of the invention are used to train a generative ensemble network, to generate new images, to modify existing images, and/or to analyze images for various characteristics such as (but not limited to) depth information.

In numerous embodiments, generation applications can use image data to train generative ensemble networks. Generation applications in accordance with a variety of embodiments of the invention can use image data to generate new images and/or to modify an existing image. In many embodiments, image data includes a variety of different image data, including (but not limited to) images captured with a camera and generated images. In some embodiments, model data can include various elements of a generative model, including (but not limited) structure data, weights, and/or hyperparameters.

Although a specific example of a generation element 700 is illustrated in FIG. 7, any of a variety of generation elements can be utilized to perform processes similar to those described herein as appropriate to the requirements of specific applications in accordance with embodiments of the invention.

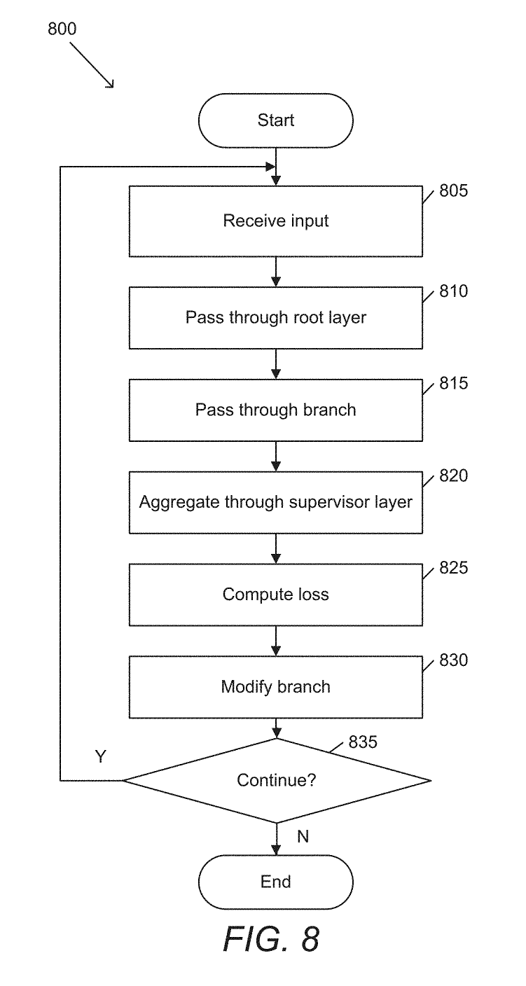

FIG. 8 conceptually illustrates a process for training a generative ensemble network. Process 800 receives (805) an input. The input in accordance with certain embodiments of the invention can include (but is not limited to) a set of one or more images, a generated output from another process (e.g., another GEN network, an artificial neural network, etc.). Process 800 passes (810) the input through a root layer. Root layers in accordance with numerous embodiments of the invention can include a convolutional layer. Process 800 passes (815) the result of the root layer through a branch of an ensemble network. In certain embodiments, each branch is trained to be responsible for varying levels of detail in an image. In various embodiments, branches are trained sequentially (or in a cascaded manner), with a first branch being trained on its own and subsequent branches being trained in conjunction with all of the trained branches. In some embodiments, all of the branches are trained in parallel. Process 800 aggregates (820) the results of the branches of the ensemble network through a supervisor layer. Process 800 computes (825) a loss for the result of the branch and modifies (830) the branch accordingly. In some embodiments, processes can backpropagate the loss (or error) through layers of a branch to modify the weights of the connections between the nodes of the branch. In many embodiments, a loss is calculated for a batch of images before it is backpropagated through a model. Process 800 then determines (835) whether to continue with the training process. When the process determines to continue training, process 800 returns to step 805 to a next image and/or to a next branch of the ensemble network.

In a number of embodiments, a training process determines to continue training as long as there are more training images and/or there are additional branches to be trained. Training in accordance with several embodiments of the invention can train each branch with all of the training data before training a next branch of the ensemble network. In many embodiments, each branch is trained on a batch of the training data before training a next batch of training data. Processes in accordance with various embodiments of the invention can train the branches in parallel, passing each training image through all of the branches at the same time.

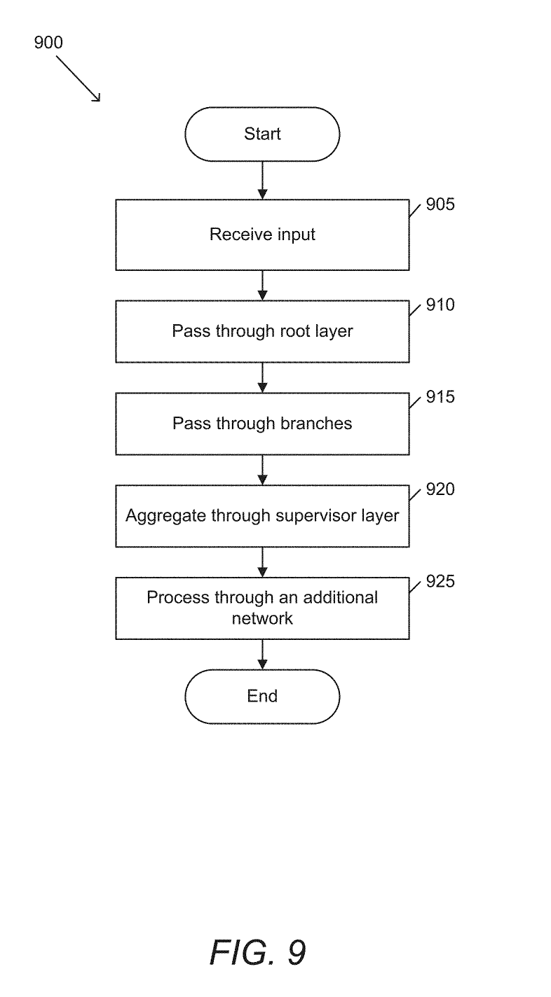

FIG. 9 conceptually illustrates a process for generating an image with a generative ensemble network. Process 900 receives (905) an input. The input in accordance with certain embodiments of the invention can include (but is not limited to) a set of one or more images, a generated output from another process (e.g., another GEN network, an artificial neural network, etc.). Process 900 passes (910) the input through a root layer. Root layers in accordance with numerous embodiments of the invention can include a convolutional layer. Process 900 passes (915) the result of the root layer through branches of an ensemble network. In certain embodiments, an image is passed through all of the branches in parallel. Process 900 passes (920) aggregates the results of the branches of the ensemble network through a supervisor layer. Process 900 processes (925) the output of the supervisor layer through an additional network. In many embodiments, the outputs of a supervisor layer are not further processed through an additional network, but rather are used as the final outputs of the system.

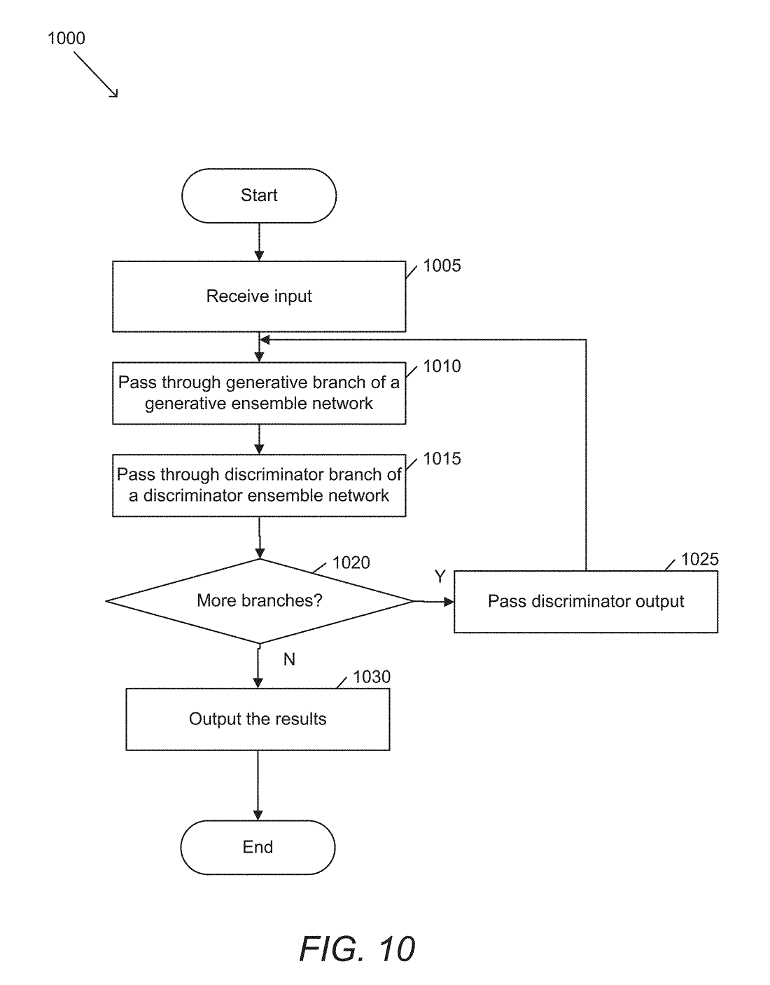

FIG. 10 conceptually illustrates a process for generating an image with a generative ensemble network and a discriminator ensemble network. Process 1000 receives (1005) an input. The input in accordance with certain embodiments of the invention can include (but is not limited to) a set of one or more images, a generated output from another process (e.g., another GEN network, an artificial neural network, etc.). Process 1000 passes (1010) the input through a generative branch of a first ensemble network. Process 1000 passes (1015) the result of the first ensemble network through a discriminator branch of a second ensemble network. Process 1000 then determines (1020) whether there are more branches of the ensemble network. When the process determines that there are additional branches, process 1000 passes (1025) the output of the discriminator branch to a next generative branch of the first ensemble network. When the process determines that there are no more branches (i.e., this is the last branch of the ensemble network) the process outputs (1030) the results.

Although specific examples of ensemble networks and methods for training them are discussed above, many different architectures and training methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for generating an image through an ensemble network architecture, the method comprising:
passing a set of one or more images through a single standard convolution layer that acts as a root node to produce a first output;
passing the first output through a plurality of branches to produce a plurality of outputs for the plurality of branches, wherein each branch is a separate and independent network that receives input from the single standard convolution layer; and
passing the plurality of outputs through a supervisor layer that combines the plurality of outputs into a final solution.

2. The method of claim 1, wherein the supervisor layer combines the plurality of outputs by summing the plurality of outputs.

3. The method of claim 1, wherein the supervisor layer combines the plurality of outputs by concatenating the plurality of outputs.

4. The method of claim 1, wherein the supervisor layer combines the plurality of outputs by delegating the outputs from each individual branch, wherein the combined output has a different width and height as the last layer in each of the plurality of branches.

5. The method of claim 4, wherein the ensemble network architecture is for performing single image super resolution (SISR) for an input image, wherein:
the plurality of branches comprises N² branches, where N is the upscaling factor;
each branch shares a same architecture; and
the supervisor layer delegates features, wherein the N² branches are repositioned along the width and height axes of the supervisor layer.

6. The method of claim 5, wherein the method further comprises correcting visual artefacts resulting from the SISR process by:
taking a neighborhood of pixels from each branch of the plurality of branches, wherein each neighborhood of pixels is derived from a corresponding low resolution pixel;
computing a delta for each neighborhood of pixels with respect to the corresponding low resolution pixel; and
applying a resulting transformation directly to the output of the supervisor layer.

7. The method of claim 1, wherein each branch of the plurality of branches utilizes a dilated architecture.

8. The method of claim 1, wherein a first branch has a first degree of network capacity and each subsequent branch of the plurality of branches exhibits an increasing degree of network capacity from the previous branch.

9. The method of claim 8, wherein the method further comprises training the ensemble network architecture in a cascaded manner, wherein branches of the plurality of branches are trained sequentially from lower network capacity to higher network capacity.

10. The method of claim 9, wherein training further comprises training all of the branches in a single pass.

11. The method of claim 1, wherein the ensemble network architecture further comprises a discriminator network, wherein the method further comprises:
passing the final solution through a second single standard convolution layer that acts as a root node of the discriminator network to produce a second output;
passing the second output through a second plurality of branches to produce a second plurality of outputs, wherein each branch is a separate and independent network that receives input from the second single standard convolution layer; and
passing the second plurality of outputs through a second supervisor layer that combines the second plurality of outputs into a second final solution.

12. The method of claim 11, wherein the discriminator network is stored and used during inference.

13. The method of claim 12, wherein the result of N branches of the discriminator network is used as an input to the N+1 branch of the generator network.

14. The method of claim 1, wherein the discriminator network comprises a plurality of discriminators for the plurality of branches, wherein the result of a set of one or more discriminators of the plurality of discriminators is used as an input to a next branch of the plurality of branches.

15. A non-transitory machine readable medium containing processor instructions for generating an image through an ensemble network architecture, where execution of the instructions by a processor causes the processor to perform a process that comprises:
passing a set of one or more images through a single standard convolution layer that acts as a root node to produce a first output;
passing the first output through a plurality of branches to produce a plurality of outputs for the plurality of branches, wherein each branch is a separate and independent network that receives input from the single standard convolution layer; and passing the plurality of outputs through a supervisor layer that combines the plurality of outputs into a final solution.

16. The non-transitory machine readable medium of claim 15, wherein the supervisor layer combines the plurality of outputs by summing the plurality of outputs.

17. The non-transitory machine readable medium of claim 15, wherein the supervisor layer combines the plurality of outputs by concatenating the plurality of outputs.

18. The non-transitory machine readable medium of claim 15, wherein the supervisor layer combines the plurality of outputs by delegating the outputs from each individual branch, wherein the combined output has a different width and height as the last layer in each of the plurality of branches.

19. The non-transitory machine readable medium of claim 18, wherein the ensemble network architecture is for performing single image super resolution (SISR) for an input image, wherein:
the plurality of branches comprises N2 branches, where N is the upscaling factor; each branch shares a same architecture; and
the supervisor layer delegates features, wherein the N2 branches are repositioned along the width and height axes of the supervisor layer.

20. The non-transitory machine readable medium of claim 19, wherein the non-transitory machine readable medium further comprises correcting visual artefacts resulting from the SISR process by:
taking a neighborhood of pixels from each branch of the plurality of branches, wherein each neighborhood of pixels is derived from a corresponding low resolution pixel;
computing a delta for each neighborhood of pixels with respect to the corresponding low resolution pixel; and
applying a resulting transformation directly to the output of the supervisor layer.
